(19) United States
(12) Patent Application Publication
(10) Pub. No.: US 2010/0131597 A1
(43) Pub. Date: May 27, 2010

(54) COMMUNICATION CONTROL DEVICE AND METHOD FOR AUTOMATICALLY SETTING UP AN INSTANT MESSAGING COMMUNICATION WHILE BEING PUT ON HOLD DURING A TELEPHONE OR MULTIMEDIA CALL

(75) Inventors: Rabih Abou Chakra, Cormeilles En Parisis (FR); Jean Francois Leroy, Gouesnou (FR)

Correspondence Address: FAY SHARPE/LUCENT, 1228 Euclid Avenue, 5th Floor, The Halle Building, Cleveland, OH, 44115-1843, US

(73) Assignee: Alcatel Lucent, Paris (FR)

(21) Appl. No.: 11/574,782

(22) PCT Filed: Feb. 14, 2007
(86) PCT No.: PCT/FR07/50797

§ 371 Date: Apr. 10, 2007

(30) Foreign Application Priority Data
Feb. 14, 2006 (FR) 0650424

(51) Int. Cl. G06F 15/16

(52) U.S. Cl. 709/206

(57) ABSTRACT

A device (D) is dedicated to the control of communications of communication terminals (T1, T2) capable of establishing at least telephone or multimedia communications. This device (D) comprises control means (MC) responsible, when a telephone or multimedia communication is established between a first communication terminal (T1) of a first user and a second communication terminal (T2) of a second user, and when an action on the first terminal (T1) causes the second terminal (T2) to be placed on hold, for proposing the establishment of an instantaneous messaging communication via the Internet or an Intranet between communication terminals of the first and second users, so that they can exchange text messages.

The invention relates to the domain of (tele)communications and more precisely control of communications when one of the persons participating in a telephone or multimedia communication is put on hold.

When a telephone or multimedia communication has been setup between first and second communication terminals used by first and second persons, and one of these terminals receives a call from a third terminal or attempts to call a third terminal, the second terminal may be put on hold.

The second user is then no longer in a position to talk to the first user or ask him anything, for example how long the hold will last, unless he hangs up and then calls the first terminal again.

At the same time, the first user is no longer in a position to inform the second user, for example to ask him a question or to specify how long his hold will last, unless he puts the user of the third terminal on hold. However, then the third user is faced with the same problem that arises due to being put on hold.

The second (or first) user can then attempt to setup an Instant Messaging (IM) communication through the Internet with the first (or second) user. However, this requires that the first and second terminals be capable of setting up instant messaging communications. This operation is not automated in networks according to the previous state of the art.

The second (or first) user can also attempt to send an email to the first (or second) user. However, this is only possible if the first and second terminals are capable of exchanging emails or if the first user and/or the second user have an additional terminal capable of exchanging emails. Furthermore and above all, the electronic messaging service of the terminal to which the email is addressed must have been switched on first so that it can notify the user about the arrival of an email.

The purpose of the invention is therefore to improve this situation.

To achieve this, it proposes a method dedicated to control of communications between the first and second users each equipped with at least first and second communication terminals capable of setting up telephone or multimedia communications.

This method is characterized by the fact that it consists of automatically proposing to set up an instant messaging communication through the Internet or an Intranet between communication terminals used by the first and second users when a telephone or multimedia communication has been setup between the first and second terminals and when action taken on the first terminal is likely to put the second terminal on hold, so that the first and second terminals can exchange text messages.

The method according to the invention may include other characteristics that may be taken separately or in combination, and particularly:
the terminal of the first user who sets up the instant messaging communication may be the first terminal;
the terminal of the second user participating in the instant messaging communication may be the second terminal;
the terminal of the first user who participates in the instant messaging communication may be a first additional terminal capable of setting up at least one instant messaging communication through the Internet or an Intranet;
the terminal of the second user who participates in the instant messaging communication may be a second additional terminal capable of setting up at least one instant messaging communication through the Internet or an Intranet;
subsequent to the action, a proposal may be made to the first terminal or to the first additional terminal and/or to the second terminal or to the second additional terminal, to setup an instant messaging communication;
the action may result from an attempt by the first terminal to setup a telephone or multimedia communication with a third terminal capable of setting up telephone or multimedia communications, or a third terminal with the first terminal. It may also be a deliberate action by the first user;
before starting to set up an instant messaging communication, this setting up may be proposed to the first and/or the second user(s), and said setup may be initiated only if at least one agreement is received.

The invention also proposes a device dedicated to controlling communications between communication terminals capable of setting up at least telephone or multimedia communications.

This control device is characterized by the fact that it comprises control means designed to (automatically) propose to setup an instant messaging communication through the Internet or Intranet between communication terminals of the first and second users when a multimedia or telephone communication is setup between the first terminal of a first user and a second communication terminal of a second user, and when action taken on the first terminal would put the second terminal on hold, so that the first and second users can exchange text messages.

The device according to the invention may comprise other characteristics that can be taken separately or in combination, and particularly:
if there is a first terminal capable of setting up instant messaging communications, the control means may be designed to propose to the first terminal to setup an instant messaging communication;
if there is a second terminal capable of setting up instant messaging communications, the control means may be designed to propose to the second terminal and/or the first terminal to setup an instant messaging communication;
if there is a first terminal present incapable of setting up instant messaging communications, the control means must know (or determine) the communication address of a first additional terminal of the first user, capable of setting up at least instant messaging communications through the Internet or the Intranet so as to propose to setup the instant messaging communication to the first terminal or the first additional terminal and/or the second terminal;
if there is a second terminal present incapable of setting up instant messaging communications, the control means must know (or determine) the communication address of a second additional terminal of the second user, capable of setting up at least instant messaging communications through the Internet or the Intranet, so as to propose to setup the instant messaging communication to the first terminal or the first additional terminal and/or the second terminal or the second additional terminal;
its control means may be designed to propose setting up an instant messaging communication following detection of an action resulting from an attempt of the first terminal to setup a telephone or multimedia communication with a third terminal capable of setting up telephone or multimedia communications or a third terminal with the first terminal, or a deliberate action by the first user;
its control means may be designed to propose to setup an instant messaging communication to the first and/or the second user(s), and to initiate this setup if at least one agreement is received.

The invention also proposes a server equipped with a control device of the type described above.

Other characteristics and advantages of the invention will become clear after examining the description given below and the appended drawings on which:

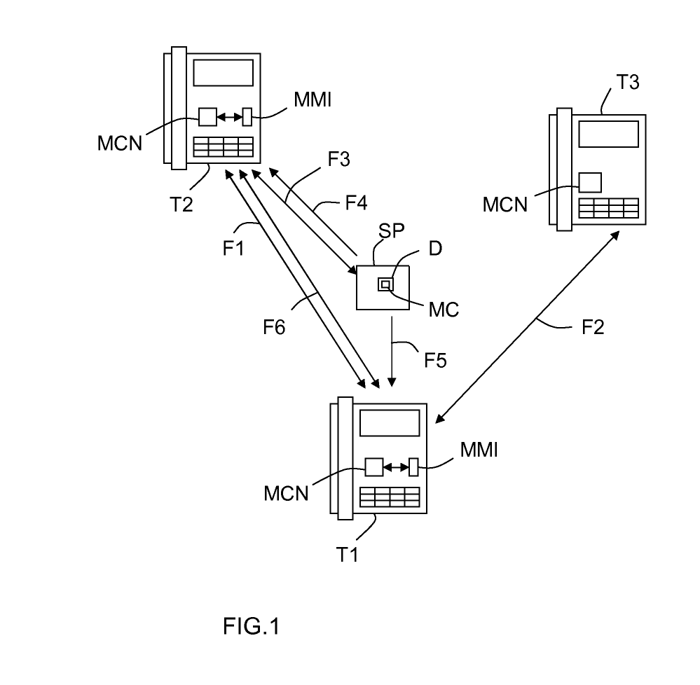

FIG. 1 very schematically and functionally illustrates a main server in which a first example embodiment of a control device according to the invention is installed, and three user terminals, two of which have setup a telephone communication during which one is put on hold because the other is in communication with the third one,

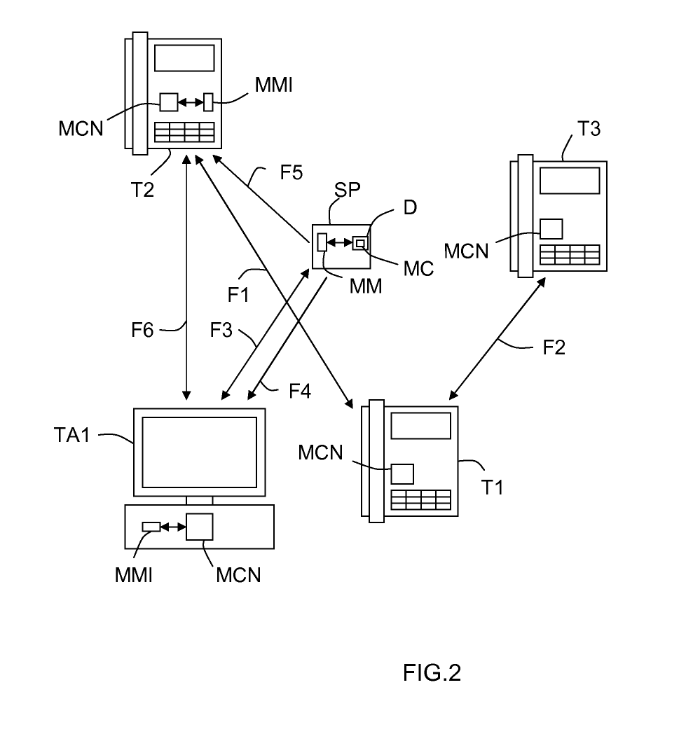

FIG. 2 very schematically and functionally illustrates a main server in which a second example embodiment of a control device according to the invention is installed, and four user terminals, two of them having setup a telephone communication during which one is put on hold because the other is in communication with a third one, and a fourth being used to setup an instant messaging communication.

The attached drawings are useful firstly as a complement to the invention, but also to contribute to defining it if necessary.

The purpose of the invention is an automatic proposal to setup an instant messaging communication through the Internet or an Intranet between user terminals when these user terminals have already setup a telephone or multimedia communication with two of their terminals, and one of them puts the other on hold.

For the purposes of this description, a “communication terminal” is any equipment with a communication module (MCN) that it can use to setup telephone or multimedia communications and to put equipment with which it has setup a telephone or multimedia communication on hold, and also possibly but not necessarily to setup instant messaging communications through the Internet or an Intranet. It could therefore be, for example, a fixed or mobile telephone, a desktop or laptop communicating computer, or a communicating Personal Digital Assistant (PDA).

FIG. 1 shows the invention firstly in general, and then as a first example embodiment.

The invention proposes to install a device D in a communication network, dedicated to controlling communications of terminals (communication terminals) Ti (in this case i=1 to 3) belonging to users. In the non-limitative example shown in FIG. 1, the control device D is installed in a main server SP connected to the communication network.

A control device D according to the invention comprises a control module MC responsible for taking action whenever a telephone or multimedia communication (arrow F1 in FIG. 1) has been setup between a terminal (for example the first terminal T1) belonging to a (first) user and another terminal (for example the second terminal T2) belonging to a second user, and action on the first (terminal T1 results in the second terminal T2 being put on hold.

To achieve this, the control module MC is coupled through the main server SP to network communication equipment, particularly so as to detect when the terminals of client users have setup a communication and when they are requested to participate in another communication. Although it is not shown in the figures, the main server SP may possibly be coupled to the network through another server dedicated to telephone or multimedia communications.

For the purposes of this description, an “action causing a second terminal to be put on hold” refers to an action carried out by a user on his first terminal (already in communication with the second terminal) that will ask this first terminal to setup a telephone or multimedia communication with a third terminal (capable of setting up telephone or multimedia communications), or to setup another telephone or multimedia communication between the first terminal and a third terminal at the initiative of the third terminal (incoming call), or a deliberate action by a user on his first terminal, independently of another communication.

When the two conditions mentioned above (first communication setup and action) are combined, the control module MC automatically proposes to setup an instant messaging (IM) communication through the Internet or an Intranet to the first user and/or to the second user between communication terminals belonging to them, so that they can exchange text messages.

For the purposes of this description, an “instant messaging communication through the Internet or an Intranet” means a communication used to exchange text or hypertext.

The terminals involved in automatically setting up the instant messaging communication proposed by a control module MC are not necessarily the first terminal T1 and the second terminal T2 that setup the first telephone or multimedia communication.

For the same terminals to perform both actions, they would both need to have an instant messaging service application module MMI coupled to the communication module MCN to setup instant messaging communications through the Internet or an Intranet. This is the case particularly for the first terminal T1 and the second terminal T2 shown in FIG. 1 in the form of fixed telephones (as a non-limitative example).

However, this is not necessarily the case. The invention is also applicable to situations in which the first and/or second user has (have) a first additional communication terminal (TA1) and/or a second additional communication terminal (TA2) with an application instant messaging service module MMI that they can use to setup instant messaging communications through the Internet or an Intranet. Thus, in the example shown in FIG. 2, the first user has a first terminal T1 capable of setting up telephone or multimedia communications and a first additional terminal TA1 provided with an instant messaging service application module MMI while the second user has a single second terminal T2 on which an instant messaging service application module MMI is installed.

In a first variant (not shown), the second user may have a second terminal (T2) capable of setting up telephone or multimedia communications, and a second additional terminal (TA2) provided with an instant messaging service application module MMI, while the first user has a single first terminal (T1) with an instant messaging service application module MMI.

In a second variant not shown, the first user may have a first terminal T1 capable of setting up telephone or multimedia communications, and a first additional terminal TA1 provided with an instant messaging service application module MMI, and a second user may have a second terminal (T2) capable of setting up telephone or multimedia communications, and a second additional terminal (TA2) provided with an instant messaging service application module MMI.

We will now describe the situation shown in the first example in FIG. 1 in more detail, in which the first and second terminals T1 and T2 both have an instant messaging service application module MMI. In this example, we will consider that instant messaging communications are made through the Internet, as an illustrative and non-limitative example.

When the control module MC detects that a first communication (arrow F1) has been set-up between the first terminal T1 and the second terminal T2 and that an action resulting from setting up a second communication between the third terminal T3 and its first terminal T1 (arrow F2), will cause the second terminal T2 to be put on hold, it addresses a message to the first terminal T1 and/or the second terminal T2 proposing to set-up an instant messaging communication through the Internet with the second terminal T2 or the first terminal T1. This message is transmitted after the second terminal T2 has actually been put on hold.

Note that before transmitting a proposal message, the control module MC can check to see if the terminals T1 and T2 have an instant messaging service application module MMI. This verification is not useful when all client terminals are adapted to telephone or multimedia communications and to instant messaging communications. To make this check, the control module MC accesses memory means (for example a database or a memory) in which at least the communication identifiers of client user terminals are stored with their communication characteristics (telephone or multimedia and/or instant messaging), corresponding to customer identifiers. These memory means may be installed in the main server SP or in another server accessible to this main server.

Preferably, the control module MC addresses a message to the second terminal T2, because this is the terminal that is on hold. However, this is not essential. It can address a message to the first terminal T1, or it can address messages to the first terminal T1 and to the second terminal T2 in parallel. In the example show in FIG. 1, the control module MC addresses a message to the second terminal T2 (arrow F3).

For example, the proposal message is a text message displayed on the screen of the second terminal T2. However, it could also be a synthesized voice message.

The control module MC waits for a response, in this case from the second terminal T2. However, in the variants mentioned above, it could wait for a response from the first terminal T1 or responses from the first terminal T2 and the second terminal T2.

If at least one setup refusal is received or if there is no reply within a chosen time, the control module MC interrupts its action and no instant messaging communication is setup between the first terminal T1 and the second terminal T2.

On the other hand, if at least one agreement is received (in this case from T2), the control module MC sends an instruction message, preferably to the terminal that sends its agreement first (arrow F4 or F5), ordering its instant messaging service application module MMI to setup an instant messaging communication with the instant messaging service application module MMI of the other terminal (in this case T1). This communication may possibly be done using a server dedicated to this purpose and coupled to the main server SP and to the network.

The instant messaging service application modules MMI on the first terminal T1 and the second terminal T2 then setup the instant messaging communication between them (arrow F6), so that the first user and/or the second user can exchange text messages if they wish, although the second terminal T2 is put on hold by the first terminal T1 due to the action that occurred. At the same time, the first and third users can communicate together by telephone or multimedia, using their first terminal T1 and third terminal T3.

We will now describe the situation shown in the second example in FIG. 2 in more detail. In this second example, the first user has a first terminal T1 capable of setting up telephone or multimedia communications, for example such as a fixed telephone, and a first additional terminal TA1 provided with an instant messaging service application module MMI, for example a desktop computer, while the second user has a second unique terminal T2 on which an instant messaging service application module MMI is installed, for example such as a fixed telephone.

When the control module MC detects that a first communication (arrow F1) has been setup between the first terminal T1 and the second terminal T2, and that an action resulting from setting up a second communication between the third terminal T3 and its first terminal T1 (arrow F2) will put the second terminal T2 on hold, it must send a message to propose setting up an instant messaging communication through the Internet to the first user and/or the second user.

Firstly, the control module MC checks if the terminals T1 and T2 have an instant messaging service application module MMI. To do this, it accesses memory means MM (for example a database or a memory) in which at least the communication identifiers of customer user terminals are stored with their communication characteristics (telephone or multimedia and/or instant messaging) corresponding to customer identifiers. These memory means MM may be located in the main server SP as shown in FIG. 2, or in another server accessible to the main server SP.

Since the first terminal T1 is not capable of setting up instant messaging communications, the control module MC determines if the first user has an additional terminal that enables him to do so. This is the case in this example. The control module MC can then transmit a proposal message either to the first terminal T1, or to the first additional terminal TA1, or to the second terminal T2, or to the second terminal T2 and the first terminal T1 or to the first additional terminal TA1. In the example shown in FIG. 2, the control module MC transmits a proposal message to the first additional terminal TA1 (arrow F3). To do this, the control module MC must know (or determine) the communication address of the first additional terminal TA1. For example, this could be stored in the memory means MM.

If at least one setup refusal is received or if there is no reply within a chosen time, the control module MC interrupts its action and no incident messaging communication is setup.

On the other hand, if at least one agreement is received (in this case from TA1), the control module MC addresses an instruction message to the terminal that sent its agreement first (arrow F4 or F5), in this case TA1, ordering its instant messaging service application module MMI to setup an instant messaging communication with the instant messaging service application module MMI on the other terminal (in this case T2). This latter communication may possibly be made through a server dedicated to this purpose coupled to the main server SP and to the network.

Instant messaging service application modules MMI of the first additional terminal TA1 and the second terminal T2 then setup an instant messaging communication between themselves (arrow F6), so that the first user and/or the second user can exchange text messages if they wish, even if second terminal T2 is put on hold by the first terminal T1 due to the action that occurred. At the same time, the first and third users can communicate together, by telephone or multimedia, using their first terminal T1 and third terminal T3.

In the first variant presented above, the second user has a second terminal T2 capable of setting up telephone or multimedia communications, and a second additional terminal TA2 on which an instant messaging service application module MMI is installed, while the first user only has a single first terminal T1 on which an instant messaging service application module MMI is installed.

In this case, when the control module MC detects that a first communication has been setup between its first terminal T1 and second terminal T2, and that an action resulting from setting up a second communication between the third terminal T3 and its first terminal T1 will cause the second terminal T2 to be put on hold, it must address a message proposing to setup an instant messaging communication through the Internet to the first user and/or the second user.

The control module MC starts by checking if the terminals T1 and T2 have an instant messaging service application module MMI. It does this by accessing the memory means MM. Since the second terminal T2 is not capable of setting up instant messaging communications, the control module MC determines if the second user has an additional terminal that he can use for this purpose. This is the case in this example. The control module MC can then send a proposal message either to the first terminal T1, or to the second terminal T2, or to the second additional terminal TA2, or to the second terminal T2 or the second additional terminal TA2 and the first terminal T1. If a proposal message is transmitted to the first terminal TA1 and/or to the second additional terminal TA2, the control module MC must know (or determine) its (or their) communication address(es). For example, this (or these) may be stored in the memory means MM.

If at least one setup refusal is received, or if there is no reply within a chosen time, the control module MC interrupts its action and no instant messaging communication is setup.

On the other hand, if at least one agreement is received (for example from TA2), the control module MC addresses an instruction message to the terminal that transmitted an agreement first (arrow F4 or F5), in this case TA2, ordering its instant messaging service application module MMI to setup an instant messaging communication with the instant messaging service application module MMI of the other terminal (in this case T1). This latter communication may be made through a server dedicated to this purpose and coupled to the main server SP and to the network.

The instant messaging service application modules MMI of the first terminal T1 and the second additional terminal TA2 then setup the instant messaging communication between themselves, so that the first user and/or the second user can exchange text messages, if they wish, even though the second terminal T2 is put on hold by the first terminal T1 due to the action that occurred. At the same time, the first and third users can communicate with each other, by telephone or multimedia, using their first terminal T1 and third terminal T3.

In the second variant presented above, the first and second users have a first terminal T1 and a first additional terminal TA1, and a second terminal T2 and a second additional terminal TA2, respectively.

In this case, when the control module MC of the first terminal T1 detects that a first communication has been setup between its first terminal T1 and the second terminal T2, and that an action resulting from setting up a second communication between the third terminal T3 and its first terminal T1 will put the second terminal T2 on hold, it must send a message to propose setting up an instant messaging communication through the Internet to the first user and/or to the second user.

The control module MC starts by checking if the terminals T1 and T2 have an instant messaging service application module MMI. It does this by accessing the memory means MM. Since the first terminal T1 and the second terminal T2 are not capable of setting up instant messaging communications, the control module MC determines if the first and second users both have an additional terminal that can do so. This is the case in this example. The control module MC can then send a proposal message either to the first terminal T1, or to the second terminal T2, or to the first additional terminal TA1, or to the second additional terminal TA2, or to the second terminal T2 or to the second additional terminal TA2 and to the first terminal TA1 or to the first additional terminal TA1. If a proposal message is transmitted to the first additional terminal TA1 and/or to the second additional terminal TA2, the control module MC must notify (or determine) its (their) communication address(es). For example, these addresses may be stored in the memory means MM.

If at least one refusal to setup is received or if there is no response within the chosen time, the control module MC interrupts its action and no instant messaging communication is setup.

On the other hand, if at least one agreement is received (for example from TA2), the control module MC sends an instruction message to the terminal that transmitted its agreement first, in this case TA2, ordering its instant messaging service application module MMI to setup an instant messaging communication with the instant messaging service application module MMI of the other terminal (in this case TA1). This latter communication could be made through a server dedicated to this purpose and coupled to the main server SP and to the network.

The instant messaging service application modules MMI of the first additional terminal TA1 and the second additional terminal TA2 then setup an instant messaging communication between themselves, so that the first user and/or the second user can exchange text messages if they wish, even when the second terminal T2 is put on hold by the first terminal T1 due to the action that occurred. At the same time, the first and the third users can communicate with each other by telephone or multimedia, using their first terminal T1 and third terminal T3.

The control device D according to the invention, and particularly its control module MC, may be made in the form of electronic circuits, software (or computer) modules, or a combination of circuits and software.

The invention may also be considered as a method of controlling communications that can be implemented between user terminals, for example of the types presented above with reference to FIGS. 1 and 2.

This method is characterized by the fact that when a telephone or multimedia communication has been setup between the first terminal T1 and the second terminal T2, and when an action on the first terminal T1 could put the second terminal T2 on hold, it consists of automatically proposing to setup an instant messaging communication following this action, through the Internet or the Intranet between communication terminals (T1 and T2, or T1 and TA2, or TA1 and T2, or even TA1 and TA2) belonging to the first and second users, so that they can exchange text messages between themselves.

The invention is not limited to the embodiments of the control device, server and methods described above solely as examples, but it encompasses all variants that those skilled in the art might consider within the framework of the claims set forth below.

1. Communication control method between a first user and a second user equipped with at least a first communication terminal (T1) and a second communication terminal (T2) respectively, capable of setting up telephone or multimedia communications, characterized in that it consists of proposing to set up an instant messaging communication through the Internet or an Intranet between communication terminals used by said first and second users when a telephone or multimedia communication has been setup between said first terminal (T1) and said second terminal (T2) and when action taken on the first terminal (T1) would put the second terminal (T2) on hold, so that the first and second users can exchange text messages, following said action.

2. Method according to claim 1, characterized in that the terminal of said first user who sets up said instant messaging communication is said first terminal (T1).

3. Method according to claim 1, characterized in that the terminal of said first user who sets up said instant messaging communication is said first terminal, and further characterized in that the terminal of said second user who participates in said instant messaging communication is said second terminal (T2).

4. Method according to claim 1, characterized in that the terminal of said first user who sets up said instant messaging communication is said first terminal, and in that the terminal of said second user who participates in said instant messaging communication is said second terminal, and further characterized in that the terminal of said first user who participates in said instant messaging communication is a first additional terminal (TA1) capable of setting up at least one instant messaging communication through the Internet or an Intranet.

5. Method according to claim 1, characterized in that the terminal of said first user who sets up said instant messaging communication is said first terminal, and further characterized in that the terminal of said second user who participates in said instant messaging communication is a second additional terminal (TA2) capable of setting up at least one instant messaging communication through the Internet or an Intranet.

6. Method according to claim 2, characterized in that subsequent to said action, a communication is set up with said first terminal (T1) or said first additional terminal (TA1) and/or said second terminal (T2) or said second additional terminal (TA2) to make a proposal for setting up an instant messaging communication.

7. Method according to claim 1, characterized in that said action results from an attempt by said first terminal (T1) to setup a telephone or multimedia communication with a third terminal (T3) capable of setting up telephone or multimedia communications.

8. Method according to claim 1, characterized in that said action results from an attempt by a third terminal (T3) to setup a telephone or multimedia communication with said first terminal (T1).

9. Method according to claim 1, characterized in that said action results from a deliberate action by the first user.

10. Method according to claim 1, characterized in that before starting said setting up of an instant messaging communication, this setting up is proposed to said first and/or the second user(s) and said setup is initiated only if at least one agreement is received.

11. Communication control device (D) between communication terminals (T1, T2), capable of setting up at least telephone or multimedia communications, characterized in that it comprises control means (MC) designed to propose to setup an instant messaging communication through the Internet or Intranet between communication terminals of said first and second users when a multimedia or telephone communication is setup between a first communication terminal (T1) of a first user and a second communication terminal (T2) of a second user, and when action taken on the first terminal would put the second terminal (T2) on hold, so that the first and second users can exchange text messages.

12. Device according to claim 11, characterized in that if there is a first terminal (T1) capable of setting up instant messaging communications, said control means (MC) are designed to propose to said first terminal (T1) to setup said instant messaging communication.

13. Device according to claim 11, characterized in that if there is a first terminal (T1) capable of setting up instant messaging communications, said control means (MC) are designed to propose to said first terminal (T1) to setup said instant messaging communication, and further characterized in that if there is a second terminal (T2) capable of setting up instant messaging communications, said control means (MC) are designed to propose to said second terminal (T2) and/or said first terminal (T1) to setup an instant messaging communication.

14. Device according to claim 11, characterized in that if there is a first terminal (T1) incapable of setting up instant messaging communications, said control means (MC) are designed to determine the communication address of a first additional terminal communication (TA1) of the first user, capable of setting up at least instant messaging communications through the Internet or an Intranet, and to propose setting up the instant messaging communication to said first terminal (T1) or to said first additional terminal (TA1) and/or to said second terminal (T2).

15. Device according to claim 11, characterized in that if there is a second terminal (T2) incapable of setting up an instant messaging communication, said control means (MC) are designed to determine the communication address of a second additional terminal (TA2) of the second user, capable of setting up at least instant messaging communications through the Internet or an Intranet, and to propose setting up of the instant messaging communication to said first terminal (T1) or to said first additional terminal (TA1) and/or to said second terminal (T2) or to said additional second terminal (TA2).

16. Device according to claim 11, characterized in that said control means (MC) are designed to propose setting up said instant messaging communication following detection of an action resulting from an attempt of said first terminal (T1) to setup a telephone or multimedia communication with a third terminal (T3) capable of setting up telephone or multimedia communications.

17. Device according to claim 11, characterized in that said control means (MC) are designed to propose to setup said instant messaging communication following detection of an action resulting from an attempt of a third terminal (T3) to setup a telephone or multimedia communication with said first terminal (T1).

18. Device according to claim 11, characterized in that said control means (MC) are designed to propose to setup said instant messaging communication following detection of an action resulting from a deliberate action by the first user.

19. Device according to claim 11, characterized in that said control means (MC) are designed to propose to set up an instant messaging communication to the first terminal (T1) or to first the additional terminal (TA1) and/or to the second terminal (T2) or the second additional terminal (TA2), and to initiate said setup if at least one agreement is received.

20. Server (SP), characterized in that it includes a control device (D) according to claim 11.
